(19) United States
(12) Patent Application Publication
(10) Pub. No.: US 2009/0112963 A1
(43) Pub. Date: Apr. 30, 2009

(54) METHOD TO PERFORM A SUBTRACTION OF TWO OPERANDS IN A BINARY ARITHMETIC UNIT PLUS ARITHMETIC UNIT TO PERFORM SUCH A METHOD

(75) Inventors: Wilhelm Haller, Remshalden (DE); Guenter Mayer, Schoenaich (DE); Veit Gernhoefer, Holzgerlingen (DE); Ulrich Krauch, Dettenhausen (DE); Simon Fabel, Stuttgart (DE)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/926,582

(22) Filed: Oct. 29, 2007

(51) Int. Cl. G06F 7/508

(52) U.S. Cl. 708/710

(57) ABSTRACT

A method, circuit apparatus, and a design structure on which the circuit resides, is provided to perform a subtraction of two operands in a binary arithmetic unit by subdividing two operands into groups of equal numbers of bits, generating, by appropriate arithmetic operations, pairs of intermediate results for the particular groups of bits of the two operands comprising the same bit positions, respectively. A first intermediate result of each pair of intermediate results is generated under the assumption of a carry-in of ‘0’ and a second intermediate result of each pair of intermediate results is generated under the assumption of a carry-in of ‘1’. The correct intermediate result of each particular pair of intermediate results from each group of bits is selected, and the result of the subtraction of the two operands is generated by an appropriate merging of the selected correct intermediate results.

### CROSS-REFERENCE TO RELATED PATENT APPLICATIONS

This patent application is related to co-assigned U.S. patent application Ser. No. 11/855,658, filed on Sep. 14, 2007.

### BACKGROUND OF THE INVENTION

1. Technical Field

The present invention relates to a method and apparatus for data processing in general and in particular to a method, a circuit apparatus and design structure on which the circuit resides, to perform a subtraction of two operands in a computer system. Still more particularly, the present invention relates to a method, an apparatus, and design structure for an apparatus for performing a subtraction in a binary arithmetic unit.

2. Description of the Prior Art

Within a computer system, in order to get the magnitude result of an effective subtraction, typically two subtractions have to be performed: A minus B if the operand A is greater than or equal to operand B, and B minus A if B is greater than A. In order to achieve this, two adders working in parallel are required.

Another possibility would be to first compare the two operands and then multiplex the data to a subtractor, such that the result is always a subtraction of the larger operand minus the smaller operand. This approach has the disadvantage that an additional operation in series is necessary and an additional comparator is needed.

To reduce the amount of hardware of the two adders working in parallel, so-called end-around-carry adders (EAC) have been developed. Such an EAC is known e.g. from U.S. Pat. No. 6,061,707 and Eric M. Schwarz, “Binary Floating-Point Unit Design: the fused multiply-add dataflow”, Chapter 8, High Performance Energy Efficient Microprocessor Design (ISBN: 0-387-28594-6), Springer, July 2006, the disclosures of which are hereby incorporated by reference.

An EAC operates in the following manner. When performing a mathematical operation like e.g. adding or subtracting two operands, each bit position generates a so called Carry (Cy). Thereby the Cy of the Most Significant Bit (MSB) is the so-called Carry-Out (CyOut). When performing a subtraction, the CyOut indicates if the result is positive or negative. If the CyOut of a two's complement subtraction A minus B is ‘1’, then the result is positive and the operation is done. If the two's complement CyOut of A minus B is ‘0’, then the result is negative.

In case of a negative result a one's complement subtraction with a following one's complement of the result produces the magnitude of the operation. It is thus sufficient to feed the CyOut of the initial two's complement operation back as a Carry-In (CyIn) into the carry logic. It is a key feature of the EAC logic to feed the CyOut back as a CyIn. Depending on the CyOut of an EAC logic only a complement of the result is needed.

Explained with formulas, an EAC operates as follows:

n=operand width
2ⁿ−B is the two's complement of B
B′ is the one's complement of B
B′+1 is again the two's complement of B

If A is greater than or equal to B:

A−B=A+2ⁿ−B=A+B′+1

If A is smaller than B:

B−A=−(A−B)=−(A+B′+1)=−(A+B′)−1=(A+B′)′+1−1=(A+B′+0)′

Translating the above formulas into logical equations, the CyOut of a two's complement subtraction has to be the CyIn into the group carries of the subsequent adder.

If the operand length is assumed to be 4 bits wide with the index 0 being the MSB and 3 the Least Significant Bit (LSB), the CyOut of a two's complement subtraction with an assumed CyIn of ‘1’ can be determined as follows:

(A) Cy Out=g0+p0g1+p0p1g2+p0p1p2g3+p0p1p2p3 (1)

In a Subsequent Adder structure the Carries Cy0, Cy1, Cy2, Cy3 of the bit positions 0, . . . , 3 of the operand are determined in the following way:

(A) Cy0=g0+p0g1+p0p1g2+p0p1p2g3+p0p1p2p3 Cy In

(B) Cy1=g1+p1g2+p1p2g3+p1p2p3 Cy In

(C) Cy2=g2+p2g3+p2p3 Cy In

(D) Cy3=g3+p3CyIn (2)

Substituting CyOut for CyIn reduces the equation to:

(A) Cy0=g0+p0g1+p0p1g2+p0p1p2g3+p0p1p2p3

(B) Cy1=g1+p1g2+p1p2g3+p1p2p3g0+p0p1p2p3

(C) Cy2=g2+p2g3+p2p3g0+p2p3p0g1+p0p1p2p3

(D) Cy3=g3+p3g0+p3p0g1+p3p0p1g2+p0p1p2p3 (3)

Thereby g and p are logic operations with g being a Boolean generate-operation (AND) and p a Boolean propagate-operation (OR).

Regarding equation (3) it can be seen that an EAC adder has equal length carry chains. The above example is only for a 4 bit EAC. For a wider EAC, e.g. a 32 or 64 bit EAC, the equations are very complex.

Due to this, EACs face the disadvantage that all carry signals for each bit position are equally complex and have equally long logical functions. Propagate (p) and generate (g) terms from all bit positions up to the MSB are needed for the LSB carry-in and vice versa. In an EAC, not only the active logical devices but also wiring resources are doubled in the horizontal direction compared to a single addition/subtraction unit.

Thereby the problem arises that for large operands, prior EACs require wiring that is costly, which reduces performance, and requires excessive space. Due to this, up to now EACs are mainly used for smaller operands, e.g. in floating point operations with operand length of 12 or 16 bits. It would be desirable to provide a method and apparatus for performing subtractions for operands larger than 12 or 16 bits that have high performance, with minimal wiring and space requirements.

### SUMMARY OF THE INVENTION

It is therefore an object of the invention to provide a method to perform a subtraction in an arithmetic unit, which method allows reducing wiring requirements within the arithmetic unit, plus an arithmetic unit to be used to perform such a method.

In a first aspect, the invention provides a method to perform a subtraction of two operands in a binary arithmetic unit, the method comprising the steps of: subdividing each of a first operand and a second operand, each having a first bit width, into an N number of first groups of bits and an N number of second groups of bits, respectively, wherein each of said first groups has a corresponding one of said second groups having bit positions corresponding to the same bit positions of said first and second operands, and each of said first and second groups has a second bit width less than said first bit width; generating a first intermediate result (Sum0) from an appropriate arithmetic operation on each group of said first groups and said second groups having corresponding bit positions under the assumption of a carry-in of ‘0’, and a second intermediate result (Sum1) from an appropriate arithmetic operation on each of said first groups and said second groups having corresponding bit positions under the assumption of a carry-in of ‘1’; selecting a correct intermediate result from each of said first and second intermediate results for each of said groups of bits having corresponding bit positions; and generating a subtraction result from a subtraction of said first and second operands by an appropriate merging of said correct intermediate results. The selection of intermediate results may comprise an appropriate conversion, if necessary. Said appropriate merging preferably comprises e.g. assembling the selected intermediate results according to the bit positions covered by their particular groups of bits respectively. Furthermore it is contemplated that said appropriate merging comprises an inversion of an intermediate result, depending on the appropriate arithmetic operations performed to generate the intermediate results.

According to a preferred embodiment of the method according to the invention, the selection of the correct intermediate result of each particular pair of intermediate results is performed by determining the correct carry-in for each particular group of bits. Thereby the determined carry-in is used to select the particular intermediate result that has been calculated under the assumption of the carry-in determined.

According to another preferred embodiment of the method according to the invention the correct carry-in for each particular group of bits is determined according to the EAC-principles. Thereby the carry-ins only have to be determined for each group of bits and not for each bit position.

According to an additional preferred embodiment of the method according to the invention the appropriate arithmetic operations used to generate the intermediate results comprise a two's and a one's complement subtraction operation. Thereby each pair of intermediate results is generated by using a one's complement subtraction for the first intermediate result and a two's complement subtraction for the second intermediate result. Thereby one of the operands is inverted, added with the radix complement of the binary system and added with the other operand.

According to a particularly preferred embodiment of the method according to the invention, at least the generation of pairs of intermediate results for the particular groups of the two operands comprising the same bit positions respectively is performed in parallel. Preferably all operations are performed in parallel, i.e. all intermediate results for all possible carry-ins and for all groups covering all bit positions are calculated in parallel and also determining the correct intermediate results of all pairs of intermediate results is performed in parallel, e.g. by determining the carry-ins according to the EAC-principles.

Preferably the subdivision is performed in a way that each group of bits comprises four or eight bits, i.e. each group comprises a digit or a byte.

In a second aspect, the invention provides an arithmetic unit to be used to perform any one of the methods mentioned above. Said binary arithmetic unit comprises: means to subdivide two operands of equal bit-lengths to be subtracted from each other into groups of equal numbers of bits, wherein the subdivision is identical for both operands, i.e. both operands are subdivided into groups of bits comprising the same bit positions within each operand; means to generate pairs of intermediate results for the particular groups of the two operands comprising the same bit positions respectively by appropriate arithmetic operations, wherein a first intermediate result of each pair of intermediate results is generated under the assumption of a carry-in of ‘0’ and a second intermediate result of each pair of intermediate results is generated under the assumption of a carry-in of ‘1’; means to select an intermediate result of each particular pair of intermediate results, i.e. for each group of bits, and means to generate the result of the subtraction by an appropriate conversion of the selected intermediate results, if necessary, and merging of the selected, and converted if necessary, intermediate results of all groups of bits covering all bit positions. The conversion can comprise e.g. an inversion of the bit-values of the intermediate result.

According to a preferred embodiment of the binary arithmetic unit according to the invention the means to subdivide two operands of equal bit-lengths to be subtracted from each other into groups of equal numbers of bits and the means to generate pairs of intermediate results for the particular groups of the two operands comprising the same bit positions respectively by appropriate arithmetic operations comprise a Carry-Select-Adder Structure subdividing the operands into groups of bits and calculating pairs of intermediate results in the form of sums assuming different carry-ins for said groups. Furthermore the means to select an intermediate result of each particular pair of intermediate results comprise an End-Around-Carry Network determining the carry-ins for the groups of bits comprised in the intermediate results, respectively.

According to another preferred embodiment of the binary arithmetic unit according to the invention the means to generate the result of the subtraction by an appropriate merging of the selected intermediate results comprise at least an XOR-stage in order to invert selected intermediate results, if necessary.

According to yet another embodiment of the invention, the binary arithmetic unit according to the invention is provided in a design structure embodied in a machine readable medium for performing a method, the method comprising: means for subdividing each of a first operand and a second operand, each having a first bit width, into an n number of first groups of bits and an n number of second groups of bits, respectively, wherein each of said first groups has a corresponding one of said second groups having bit positions corresponding to the same bit positions of said first and second operands, and each of said first and second groups has a second bit width less than said first bit width; means for generating a first intermediate result (Sum0) from an appropriate arithmetic operation on each group of said first groups and said second groups having corresponding bit positions under the assumption of a carry-in of ‘0’, and a second intermediate result (Sum1) from an appropriate arithmetic operation on each of said first groups and said second groups having corresponding bit positions under the assumption of a carry-in of ‘1’; means for selecting a correct intermediate result from each of said first and second intermediate results for each of said groups of bits having corresponding bit positions; and means for generating a subtraction result of said first and second operands by an appropriate merging of said correct intermediate results.

The design structure according to the invention may be comprise a netlist, which describes the circuit implementation of the binary arithmetic unit according to the invention. The design structure may reside on a storage medium as a data format used for the exchange of layout data of integrated circuits. The design structure may include at least one of test data files, characterization data, verification data, or design specifications.

### BRIEF DESCRIPTION OF THE DRAWINGS

The foregoing, together with other objects, features, and advantages of this invention can be better appreciated with reference to the following specification, claims and drawing.

FIG. 1 shows a block diagram of an arithmetic unit according to the invention.

FIG. 2 is a flow diagram illustrating a design process used in semiconductor design, manufacturing, and/or test.

### DETAILED DESCRIPTION OF THE INVENTION

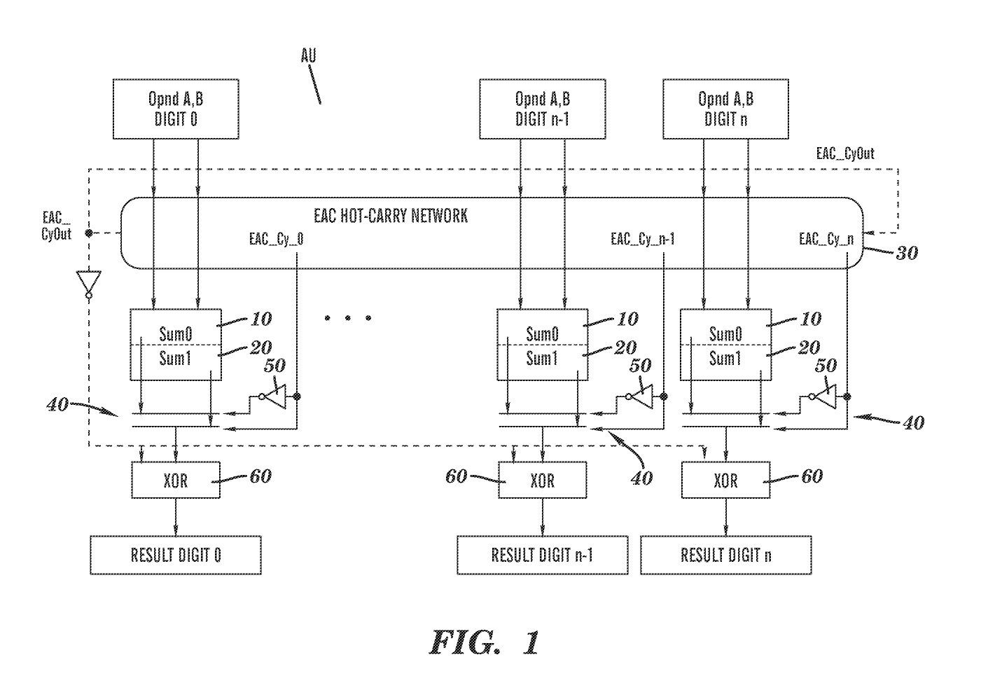

FIG. 1 shows an arithmetic unit AU according to the invention that is implemented as a Carry Select EAC adder structure. The arithmetic unit according to the invention comprises a Carry-Select-Adder structure that is adapted in order to apply the EAC-principles. This allows using the Carry-Select-Adder structure in order to perform a magnitude subtraction of two operands.

The adaptation is performed as follows. According to one aspect of the invention, the EAC equations according to equation (3) are generated only for groups of a small number of bits, e.g. 4 or 8 bits, i.e. for groups of digits or bytes, or any other appropriate group of bits.

To do so, two operands Opnd A, Opnd B to be subtracted from each other, e.g. A−B, are subdivided into groups each having an equal number of bits, e.g. into groups of 4 bits, i.e. digits. These groups are denoted by Digit 0, . . . , Digit n in FIG. 1. In a preferred embodiment of the invention, two appropriate arithmetic operations are performed in parallel for all groups Digit 0, . . . , Digit n of both operands Opnd A, Opnd B comprising the same bit positions. One arithmetic operation is performed with the assumption of a carry-in of ‘0’ (e.g. a one's complement subtraction in Block 10), and the other with the assumption of a carry-in of ‘1’ (e.g. a two's complement subtraction in Block 20). By doing so, pairs of intermediate results, denoted by Sum0 and Sum1 in FIG. 1, are generated for each group of the first and the second operand comprising the same bit positions. Preferably the intermediate results are calculated in parallel for each pair of groups of the two operands covering the same bit positions.

Thus, according to a preferred embodiment of the invention, two operands of equal bit-width to be subtracted from each other are subdivided into groups of equal numbers of bits, wherein the subdivision is identical for both operands, i.e. both operands are subdivided into groups of equal numbers of bits wherein the bits within the particular groups of the first operand take the same bit positions as the bits within the particular groups of the second operand.

The correct intermediate result of each particular pair of intermediate results is selected, i.e. for each particular group of bits. This can be performed e.g. by determining the correct carry-in for each group of bits and selecting the correct intermediate result calculated under the assumption of the particular carry-in determined.

In parallel, the EAC equations according to equation (3) are generated for the groups Digit 0, . . . , Digit n of bits in order to determine the correct carry-ins for the individual groups. These so-called EAC Hot-Carries are generated in an EAC Hot-Carry Network 30 (FIG. 1) performing the EAC equations for all groups Digit 0, . . . , Digit n according to equation (3).

With the EAC Hot-Carries used to select the precalculated Sum0 and Sum1, the group carries itself can be generated as standard adder group carries with an assumed carry-in of ‘0’ and ‘1’ respectively.

According to a preferred embodiment of the method according to the invention, the selection of the correct intermediate result of each particular pair of intermediate results is performed by determining the correct carry-in for each particular group of bits. Thereby the determined carry-in is used to select the particular intermediate result that has been calculated under the assumption of the carry-in determined.

According to another preferred embodiment of the method according to the invention the correct carry-in for each particular group of bits is determined according to the EAC-principles. Thereby the carry-ins only have to be determined for each group of bits and not for each bit position. Compared to the state of the art, this reduces the complexity of determining the carry-ins by a factor equal to the number of bits comprised in each group of bits. According to the state of the art, the EAC-principles require determining the carry-ins for each bit position. By contrast, according to the invention, this is only required for each group of bits.

An example for a digitwise grouping of the group carries is given in the following.

(A) Cyᵢ=gᵢ₊₁+Pᵢ₊₁gᵢ₊₂+Pᵢ₊₁Pᵢ₊₂gᵢ₊₃

(B) Cyᵢ₊₁=gᵢ₊₂+Pᵢ₊₂gᵢ₊₃

(C) Cyᵢ₊₂=gᵢ₊3 (4)

These are the carry equations for an assumed carry-in of ‘0’.

(A) Cyᵢ=gᵢ₊₁+pᵢ₊₁gᵢ₊₂+Pᵢ₊₁Pᵢ₊₂Pᵢ₊₃

(B) Cyᵢ₊₁=gᵢ₊₂+Pᵢ₊₂Pᵢ₊₃

(C) Cyᵢ₊₂=Pᵢ₊₃ (5)

These are the carry equations for an assumed carry-in of ‘0’.

Sum0 and Sum1 are generated, for example, in Block 10 and Block 20, respectively, with the carry functions given in equations (4) and (5), respectively. This is known from standard binary Carry Select Adder structures. According to equation (3) the EAC Hot-Carry network is reduced in complexity as only the EAC carries in groups of bits are needed.

Next is provided an example of how the EAC Hot carries may be determined for a 4 digit Carry-Select-Adder structure, i.e. a Carry-Select-Adder structure that deals with operands of a width of 16 bits that are subdivided into four groups of four bits, is shown in the following:

EAC−Cy Out=EAC−Cy0=g0+p0g1+p0p1g2+p0p1p2g3+p0p1p2p3g4+p0 . . . p4g5+p0 . . . p5g6+p0 . . . p6g7+p0 . . . p7g8+p0 . . . p8g9+p0 . . . p9g10+p0 . . . p10g11+p0 . . . p11g12+p0 . . . p12g13+p0 . . . p13g14+p0 . . . p14g15+p0 . . . p15

EAC−Cy4=g4+p4g5+p4p5g6+p4p5p6g7+p4 . . . p8g9+p4 . . . p9g10+p4 . . . p10g11+p4 . . . p11g12+p4 . . . p12 g13+p4 . . . p13g14+p4 . . . p14g15+p4 . . . p15g0+p4 . . . p15p0g1+p4 . . . p15p0p1g2+p4 . . . p15p0p1p2g3+p0 . . . p15

EAC−Cy8=g8+p8g9+p8p9g10+p8p9p10g11+p8 . . . p11g12+p8 . . . p12g13+p8 . . . p13g14+p8 . . . p14g15+p8 . . . p15g0+p8 . . . p15p0g1+p8 . . . p15p0p1g2+p8 . . . p15p0 . . . p2g3+p8 . . . p15p0 . . . p4g5+p8 . . . p15p0 . . . p5g6+p8 . . . p15p0 . . . p6g7+p0 . . . p15

EAC−Cy12=g12+p12g13+p12p13g14+p12 . . . p14g15+p12 . . . p15g0+p12 . . . p15p0g1+p12 . . . p15p0p1g2+p12 . . . p15p0 . . . p2g3+p12 . . . p15p0 . . . p3g4+p12 . . . p15p0 . . . p4g5+p12 . . . p15p0 . . . p5g6+p12 . . . p15p0 . . . p6g7+p12 . . . p15p0 . . . p7g8+p12 . . . p15p0 . . . p8g9+p12 . . . p15p0 . . . p9g10+p12 . . . p15p0 . . . 10g11+p0 . . . p15

Thereby Cy0 is the carry-out of the group comprising the MSB. The carries are denoted as they would be denoted, if the carries would have to be determined for each bit position. As it can be seen, in accordance with the invention, it is sufficient to determine only every fourth carry Cy0, Cy4, Cy8, Cy12. By contrast, according to the state of the art, within an EAC handling a 16 bit operand, sixteen carries have to be determined starting from Cy0 and ending at Cy15.

The method according to the invention has the advantage over the state of the art in that it allows the application of EAC principles within Carry-Select-Adder structures. Thereby the subtraction can be performed as fast as according to other known methods, but the requirements for wiring within the arithmetic unit are reduced. This is due to the possibility to perform EAC-principles in order to select the correct intermediate results, even for the case if the operands have a width of more than 16 bits. According to the invention the carry-ins that can be determined in order to select the correct intermediate results of the pairs of intermediate results, e.g. according to the EAC-principles, do not have to be determined for each bit position as is necessary according to the state of the art, but only have to be determined for each group of bits. Thus, the method and apparatus according to the invention reduces wiring requirements dramatically.

The method according to the invention allows operating an arithmetic unit with reduced horizontal wiring. It furthermore allows an application of intermediate results in form of standard pre-sum elements Sum0 and Sum1 as used in well-known binary adders. Thereby it is important to mention that the Sum0 and Sum1 width, i.e. the width of the groups of bits into which the operands are subdivided into, can be of any suitable length. This allows applying the EAC principles on operands with a width larger than sixteen bits. Furthermore the Sum0 and Sum1 elements are not timing critical. An additional advantage is the fact that the Sum0 and Sum1 hardware elements can be considered as standard hardware elements. However, only one hardware element has to be designed and can be reused and copied for all groups of bits.

According to an additional preferred embodiment of the method according to the invention, the appropriate arithmetic operations used to generate the intermediate results comprise a two's and a one's complement subtraction operation. Thereby each pair of intermediate results is generated by using a one's complement subtraction for the first intermediate result (Sum0) (e.g. in Block 10) and a two's complement subtraction for the second intermediate result (Sum1) (e.g. in Block 20).

In a preferred embodiment, for each group of bits, Digit 0, . . . , Digit n, there are two speculative intermediate results, Sum0, Sum1, which are input into a selector device 40 that comprises two-way multiplexor comprising a first level 41 and a second level 42, and having a common input signal, where the input is passed through an invertor 50 before reaching first level 41. One skilled in the art would understand that any appropriate selection device may be used, and the invention is not so limited to a 2-way selector. In one embodiment according to the invention, the speculative intermediate result Sum0 obtained from the one's complement subtraction (Block 10) is input into a first level 41 of a two-way multiplexer of selector 40, and similarly the speculative intermediate result Sum1 obtained from the two's complement subtraction (Block 20) is input into a second level 42 of the multiplexer of selector 40. The selection of the correct intermediate result for the group Digit i, i=0, . . . , n, is dependent on the value of the carry out EAC_CY_i obtained from the subtraction performed according to EAC principles in the Hot-Carry Network 30, for each group Digit 0, . . . , Digit n of the operands Opnd A and Opnd B. Based on the value of the carry out EAC_Cy_i, the correct intermediate result is selected, as would be understood by one skilled in the art. For example, according to a preferred embodiment of the invention, if EAC_Cy_i is “1”, then the second intermediate result Sum1 from the two's complement subtraction (from Block 20) is selected as the correct intermediate result, while if EAC_Cy_i is “0”, then the first intermediate result Sum0 from the one's complement subtraction (from Block 10) is selected as the correct intermediate result.

Furthermore it is contemplated that the appropriate merging of the intermediate results from each group Digit 0, . . . , Digit n, to form the final result of the subtraction between Opnd A and Opnd B. The merging also comprises an inversion of an intermediate result, depending on the appropriate arithmetic operations performed to generate the intermediate results. The appropriate merging preferably comprises e.g. assembling the selected intermediate results according to the bit positions covered by their particular groups of bits respectively. Referring to FIG. 1, according to one embodiment of the invention, an XOR-stage 60 is provided in order to invert selected intermediate results, if necessary, according to the carry out EAC_CyOut obtained according to EAC principles.

Thereby one of the operands is inverted, added with the radix complement of the binary system and added with the other operand. For example, according to a preferred embodiment of the invention, if CyOut is equal to “1”, then the result of the subtraction A−B is positive, and the operation is complete. If CyOut is equal to “0”, then the result of the subtraction A−B is negative and the result has to be inverted again in order to get the magnitude value of the subtraction of the two groups of bits covering the same bit positions within the two operands.

According to a particularly preferred embodiment of the method according to the invention, at least the generation of pairs of intermediate results for the particular groups of the two operands comprising the same bit positions respectively is performed in parallel. Preferably all operations are performed in parallel, i.e. all intermediate results for all possible carry-ins and for all groups covering all bit positions are calculated in parallel and also determining the correct intermediate results of all pairs of intermediate results is performed in parallel, e.g. by determining the carry-ins according to the EAC-principles.

Preferably, the subdivision is performed in a way that each group of bits comprises four or eight bits, i.e. each group comprises a digit or a byte. In a second aspect, the invention provides an arithmetic unit to be used to perform anyone of the methods mentioned above. Said binary arithmetic unit comprises means to subdivide two operands of equal bit-lengths to be subtracted from each other into groups of equal numbers of bits, wherein the subdivision is identical for both operands, i.e. both operands are subdivided into groups of bits comprising the same bit positions within each operand; means to generate pairs of intermediate results for the particular groups of the two operands comprising the same bit positions respectively by appropriate arithmetic operations, wherein a first intermediate result of each pair of intermediate results is generated under the assumption of a carry-in of ‘0’ and a second intermediate result of each pair of intermediate results is generated under the assumption of a carry-in of ‘1’; means to select an intermediate result of each particular pair of intermediate results, i.e. for each group of bits, and means to generate the result of the subtraction by an appropriate conversion of the selected intermediate results, if necessary, and merging of the selected, and converted if necessary, intermediate results of all groups of bits covering all bit positions. The conversion can comprise e.g. an inversion of the bit-values of the intermediate result.

According to a preferred embodiment of the binary arithmetic unit according to the invention the means to subdivide two operands of equal bit-lengths to be subtracted from each other into groups of equal numbers of bits and the means to generate pairs of intermediate results for the particular groups of the two operands comprising the same bit positions respectively by appropriate arithmetic operations comprise a Carry-Select-Adder Structure subdividing the operands into groups of bits and calculating pairs of intermediate results in the form of sums assuming different carry-ins for said groups. Furthermore the means to select an intermediate result of each particular pair of intermediate results comprise an End-Around-Carry Network determining the carry-ins for the groups of bits comprised in the intermediate results, respectively. Doing so allows using a Carry-Select-Adder Structure to perform EAC-principles. In the prior art, EAC principles are mainly applied on operands of a width of 12 to 16 bits only, since the calculation of the carry-ins for the bit positions gets more and more complex as the operand width increases. In accordance with the invention, the carry-ins do not have to be calculated for each bit position anymore, but only have to be calculated for each group of bits covering a certain range of bit positions. For example, in the prior art, 16 carry-ins had to be calculated when subtracting two 16 bit wide operands. Now, in accordance with the invention, assuming a subdivision into e.g. groups of 4 bits, only 4 carry-ins have to be calculated when subtracting two operands of 16 bit width. This reduces wiring requirements significantly. Thereby it is important to mention, that the same rules can be applied to calculate the carry-ins for certain ranges of bit positions covered by adjacent groups of bits and to calculate the carry-ins for individual adjacent bit positions.

According to another preferred embodiment of the binary arithmetic unit according to the invention the means to generate the result of the subtraction by an appropriate merging of the selected intermediate results comprise at least an XOR-stage in order to invert selected intermediate results, if necessary.

The arithmetic unit according to the invention provides a structure where the amount of long wires is reduced. Furthermore it allows applying standard structures of binary adders by adapting said structures in order to perform EAC principles.

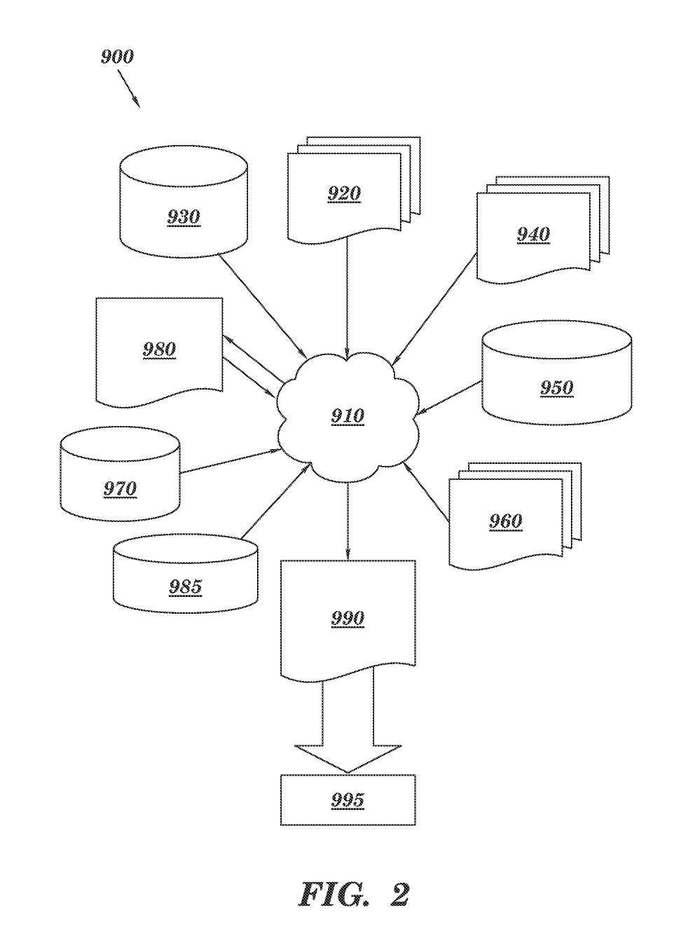

FIG. 2 shows a block diagram of an example design flow 900. Design flow 900 may vary depending on the type of IC being designed. For example, a design flow 900 for building an application specific IC (ASIC) may differ from a design flow 900 for designing a standard component. Design structure 920 is preferably an input to a design process 910 and may come from an IP provider, a core developer, or other design company or may be generated by the operator of the design flow, or from other sources. Design structure 920 comprises circuit 100 in the form of schematics or HDL, a hardware-description language (e.g., Verilog, VHDL, C, etc.). Design structure 920 may be contained on one or more machine readable medium. For example, design structure 920 may be a text file or a graphical representation of circuit 100. Design process 910 preferably synthesizes (or translates) circuit 100 into a netlist 980, where netlist 980 is, for example, a list of wires, transistors, logic gates, control circuits, I/O, models, etc. that describes the connections to other elements and circuits in an integrated circuit design and recorded on at least one of machine readable medium. This may be an iterative process in which netlist 980 is resynthesized one or more times depending on design specifications and parameters for the circuit.

Design process 910 may include using a variety of inputs; for example, inputs from library elements 930 which may house a set of commonly used elements, circuits, and devices, including models, layouts, and symbolic representations, for a given manufacturing technology (e.g., different technology nodes, 32 nm, 45 nm, 90 nm, etc.), design specifications 940, characterization data 950, verification data 960, design rules 970, and test data files 985 (which may include test patterns and other testing information). Design process 910 may further include, for example, standard circuit design processes such as timing analysis, verification, design rule checking, place and route operations, etc. One of ordinary skill in the art of integrated circuit design can appreciate the extent of possible electronic design automation tools and applications used in design process 910 without deviating from the scope and spirit of the invention. The design structure of the invention is not limited to any specific design flow.

Design process 910 preferably translates an embodiment of the invention as shown in FIG. 1, along with any additional integrated circuit design or data (if applicable), into a second design structure 990. Design structure 990 resides on a storage medium in a data format used for the exchange of layout data of integrated circuits (e.g. information stored in a GDSII (GDS2), GL1, OASIS, or any other suitable format for storing such design structures). Design structure 990 may comprise information such as, for example, test data files, design content files, manufacturing data, layout parameters, wires, levels of metal, vias, shapes, data for routing through the manufacturing line, and any other data required by a semiconductor manufacturer to produce an embodiment of the invention as shown in FIG. 1. Design structure 990 may then proceed to a stage 995 where, for example, design structure 990: proceeds to tape-out, is released to manufacturing, is released to a mask house, is sent to another design house, is sent back to the customer, etc.

While the present invention has been described in detail, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. A design structure embodied in a machine readable medium for performing a method, the method comprising:
means for subdividing each of a first operand and a second operand, each having a first bit width, into an n number of first groups of bits and an n number of second groups of bits, respectively, wherein each of said first groups has a corresponding one of said second groups having bit positions corresponding to the same bit positions of said first and second operands, and each of said first and second groups has a second bit width less than said first bit width;
means for generating a first intermediate result (Sum0) from an appropriate arithmetic operation on each group of said first groups and said second groups having corresponding bit positions under the assumption of a carry-in of ‘0’, and a second intermediate result (Sum1) from an appropriate arithmetic operation on each of said first groups and said second groups having corresponding bit positions under the assumption of a carry-in of ‘1’;
means for selecting a correct intermediate result from each of said first and second intermediate results for each of said groups of bits having corresponding bit positions; and
means for generating a subtraction result of said first and second operands by an appropriate merging of said correct intermediate results.

2. The design structure of claim 1, wherein said means for subdividing said first and second operands and said means for generating said first and second intermediate results comprise a Carry-Select-Adder Structure, and wherein said means for selecting said correct intermediate result comprise an End-Around-Carry Network.

3. The design structure of claim 1, wherein said means for generating said subtraction result comprises at least an XOR-stage in order to invert said correct intermediate results, if necessary.

4. The design structure of claim 3, wherein said means for subdividing said first and second operands and said means for generating said first and second intermediate results comprise a Carry-Select-Adder Structure, and wherein said means for selecting said correct intermediate result comprise an End-Around-Carry Network, and wherein said correct intermediate results are inverted by said XOR-stage according to a carry out from said End-Around-Carry Network.

5. The design structure of claim 1, wherein the design structure comprises a netlist.

6. The design structure of claim 1, wherein the design structure resides on storage medium as a data format used for the exchange of layout data of integrated circuits.

7. The design structure of claim 1, wherein the design structure includes at least one of test data files, characterization data, verification data, or design specifications.
